(19) United States
(12) Patent Application Publication
(10) Pub. No.: US 2002/0162109 A1
(43) Pub. Date: Oct. 31, 2002

(54) Distributed storage on a P2P network architecture

(75) Inventor: Yevgeniy Eugene Shteyn, Cupertino, CA (US)

Correspondence Address: Michael E. Schmitt, Corporate Patent Counsel, U.S. Philips Corporation, 580 White Plains Road, Tarrytown, NY, 10591, US

(73) Assignee: Koninklijke Philips Electronics N.V.

(21) Appl. No.: 09/844,570

(22) Filed: Apr. 26, 2001

(51) Int. Cl. G06F 13/00; H04N 7/173; H04N 5/445; G06F 3/00; G06F 15/16

(52) U.S. Cl. 725/87; 725/38

(57) ABSTRACT

An electronic content delivery system uses a network of end-user devices around a hub. Each end-user device has storage capability. Content is stored in a distributed fashion on the network of these end-user devices for being made available to individual ones of these devices in a P2P fashion so as to cut download time and reduce transmission errors.

### FIELD OF THE INVENTION

The invention relates to a system and method for enabling broadband services, e.g., video-on-demand (VOD), over a data network such as the Internet.

### BACKGROUND ART

Providing a quality VOD service over a peer-to-peer network presents formidable technical and organizational challenges to potential service providers. Digital video files, even compressed, are considered large for this purpose. The size of a full-feature movie in MPEG 2 format, for example, can be larger than four gigabytes. Transfer of this amount of data over a DSL, cable or T1 connection may require hours.

### SUMMARY OF THE INVENTION

An extended period of download time increases the probability of failures in the data transfer for a variety of reasons, e.g., network congestion, malfunctioning of the source and destination hardware and/or software, etc. Data transfer over the Internet involves the sending of data packets that need to go through several routers before they reach their final destination. Each time the packet is forwarded to the next router, a hop occurs. Downloading or streaming videos over the Internet is hampered by failures that occur more frequently with the increasing number of hops per data packet. Not all data gets delivered, the receiving machine freezes up, etc.

The inventor therefore proposes, among other things, a network architecture for, e.g., a cable operator to enable a broadband service, such as a video-on demand service, in a peer-to-peer network environment. The network uses high-speed reliable data network connections between service provider hubs or proxies, e.g., cable operators local stations. The end-users form a peer-to-peer network community around each hub. The peer-to-peer network provides distributed storage for content downloaded from the hub that is only a few hops away. The content is stored locally using community resources and is made available to the community via a Virtual Private Web service. This service enables content look-up, content distribution, connection set-up, copyright protection, and other facilities.

Current peer-to-peer (P2P) solutions provide low or undefined (video) quality of content, cannot guarantee a timely content delivery, and do not have proper copyright protection in place for the content. An aspect of the invention provides a scalable service, e.g., for VOD, that overcomes these drawbacks. The invention also enables a business model where the VOD service can be provided inexpensively and with high quality. Low cost of the service may further deter content piracy, which is usually associated with peer-to-peer networking.

The inventor has realized that today's Media Service Operators (e.g., cable operators, satellite operators) provide consumers with access to audio/video content via broadcast as well as through a high-bandwidth network. They also define features and software for consumer set-top boxes (STBs), which include local storage (e.g., HDD), high processing power, and IP communication capabilities. Therefore, conditions exist for creation of a hybrid public/private high-bandwidth local network with scalable and efficient content storage and routing. According to an aspect of the invention, the content, e.g. digital video, is received by a local network operator (head-end), preferably via a secure delivery mechanism. Then, the content and/or its a parts are distributed to a plurality of STBs, or other network enabled devices with storage capability, within the local network. The content is stored on the STB and registered with a lookup service, hosted by the VOD provider. The storage of the content is controlled by the service provider. The content can be encrypted or watermarked in order to prevent unauthorized access to ensure effective copyright management by the content provider. A user of the VOD service can select a content item (e.g., a movie) from the lookup service hosted by the provider. The lookup can be presented, for example, in a familiar electronic program guide (EPG) form. After the user selects the content for viewing, the service determines streaming or downloading options, based on the content location(s). Since the content and/or its parts are located on different STBs, the service may optimize content delivery based on the current network traffic load and/or routing patterns. For example, different chapters can be downloaded from different STBs onto a specific STB in order to overcome the asymmetrical (higher download speed than upload speed) nature of network access, e.g., a cable modem, satellite link, etc. For example, cable is an asymmetrical IP environment as its upload bandwidth is lower than download bandwidth. The download (server to client) speed is typically 100 kB/sec and the upload (from client to router or server) speed is about 10 kB/sec.

With respect to the download per chapter, reference is made to U.S. Ser. No. 09/433,257 (attorney docket PHA 23,782) filed Nov. 4, 1999 for Eugene Shteyn for PARTITIONING OF MP3 CONTENT FILE FOR EMULATING STREAMING. This document relates to an electronic file that is partitioned into a sequence of segments at the server side. The first segment is played out upon downloading. While the first segment is being played out, the second is being downloaded and buffered so that it is available when the play out of the first segment is completed. While playing out a current one of the segments, next one(s) of the segments are being downloaded and buffered. This partitioning ad sequential play out enables to emulate streaming of a file and to minimize latency while downloading an electronic file.

According to an aspect of the invention, the equipment of the end-users is made part of the content delivery and distribution system. Under control of the service or content provider, content is made accessible through a lookup service. Preferably, the user does not know, and does not need to know, the location of the source of the streamed content (hub, other end-users). Advantages reside in, among other things that the download distance is short due to the local availability, and that data traffic is restricted to a local network. The invention therefore relates to a method of enabling multiple end-users to receive content information. The content information is supplied to a hub, and a peer-to-peer network of respective devices residing at respective ones of the end-users is being used. As known, a hub is a common connection point for a cluster of devices thus forming a network. These devices are connected to the hub for the distributed storage of content information on the network, under control of the hub. The expression “enabling” refers to the parties upstream of a specific end-user, parties involved in getting the content information to the end-user.

### BRIEF DESCRIPTION OF THE DRAWING

The invention is explained below, by way of example and with reference to the accompanying drawing, wherein:

FIG.1 is a block diagram of a service area network in the invention;

FIGS. 2 and 3 are block diagrams illustrating functionalities in a Service Area Network in the invention; and

FIG. 4 is a block diagram for a hybrid configuration of the end-user's local storage.

Throughout the drawing, same reference numerals indicate same or corresponding features.

### DETAILED EMBODIMENTS

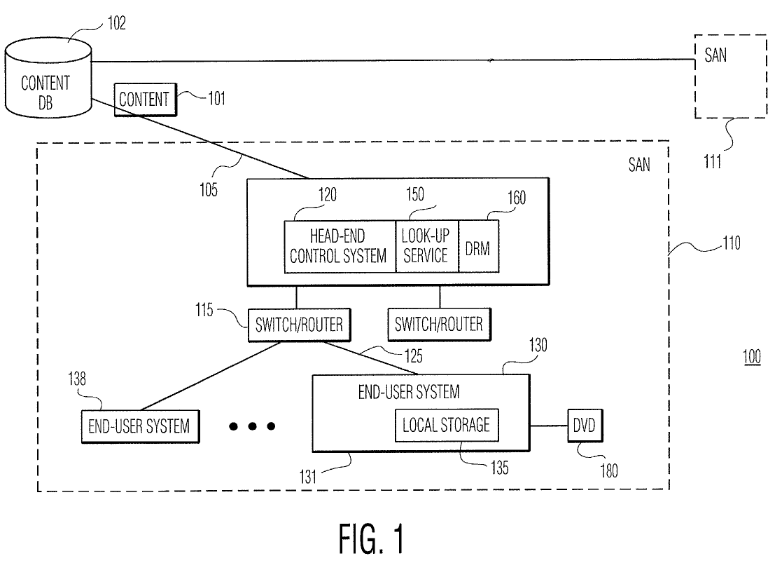

FIG. 1 is a diagram of a data processing system 100 according to the invention at the time when it is being populated with a content item 101. Content item 101 is received by a Service Area Network (SAN) 110 or 111 via a network connection 105, e.g., satellite, Internet, cable, or a physical delivery service (not shown) from an external content database 102. A head-end control system 120 of SAN 110 selects at least one end-user system 130, tests a connection 125 and downloads content item 101 or a part of thereof to system 130 using a router 115. Preferably, Host-Intelligent dynamic routing algorithms are used in the process. For further detail see, e.g., Routing Basics at http:/www.cisco.com/univercd/cc/td/doc/cisintwk/ito_doc/routing.htm. The content delivered is stored by system 130 using local storage 135, e.g., a HDD. Upon completion of the content download and verification, control system 120 registers with a look-up service 150 data relating to access of the content in local storage 135 by this end-user or another end-user 138. Alternatively, content 101 is acquired by SAN 110 via a source at the end-user system, e.g., DVD player 180. In that case, a software component 131 communicates with a digital rights management (DRM) service 160 to ensure proper protection. If the content is authorized for distribution, software component 131 stores the DVD's content on local storage 135 and updates look-up service 150. If necessary, service 160 may acquire proper distribution authorization from an external source (not shown). In a similar manner, the DVD's content can be made available for further distribution within SAN 110 to other end-user systems, e.g., system 138.

A major difference between the invention and known content information processing systems, such as the Napster service, is that the user does not control the content stored on local storage 135 and received from, e.g., database 102. The user cannot move, delete or modify the content of local storage 135 without violating the integrity of the system 130. Local storage 135 is in this example, an inherent part of the local content-distribution system of SAN 110 to make possible the content delivery service through distributed storage on SAN 110. In another aspect, the quality of the content stored on local storage 135 is guaranteed by system 100, since it uses authorized sources, such as database 102, and verifies the content during and after transfer.

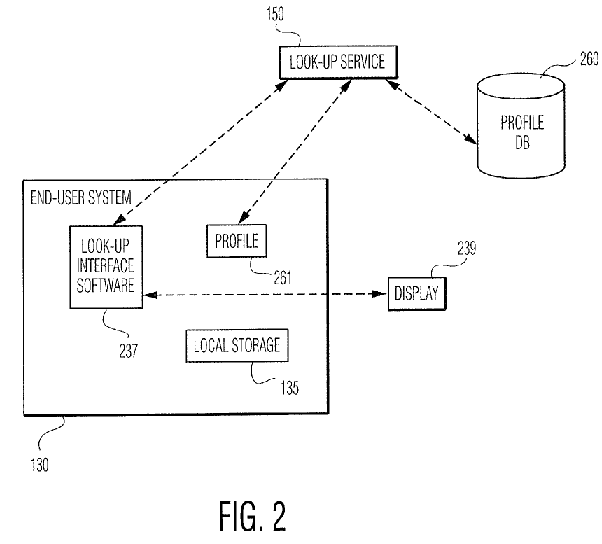

FIG. 2 is a diagram of the invention illustrating some functionalities involved when the end-user finds and selects content for play-out. A user-interface software component 237 enables the user to access look-up service 150. The contents of the look-up service can be presented via a search, browse, query, EPG (electronic program guide) or other types of interactions using, e.g., a display monitor 239 of system 130. Preferably, system 100 utilizes user-access history, e.g. a profile 261, to pre-select or recommend content available on SAN 110. The profile or parts thereof, can be stored on, e.g., user-end device 130 and/or user profile database 260. Head-end control system 120 may also determine the time slots for availability of specific content on SAN 110 based on the current and/or predicted network traffic on SAN 110. Preferably, content items with the shortest predicted delivery paths are offered/promoted first. For example, a movie that is already fully or partially stored on storage 135 or on a neighboring system 138 can be offered first.

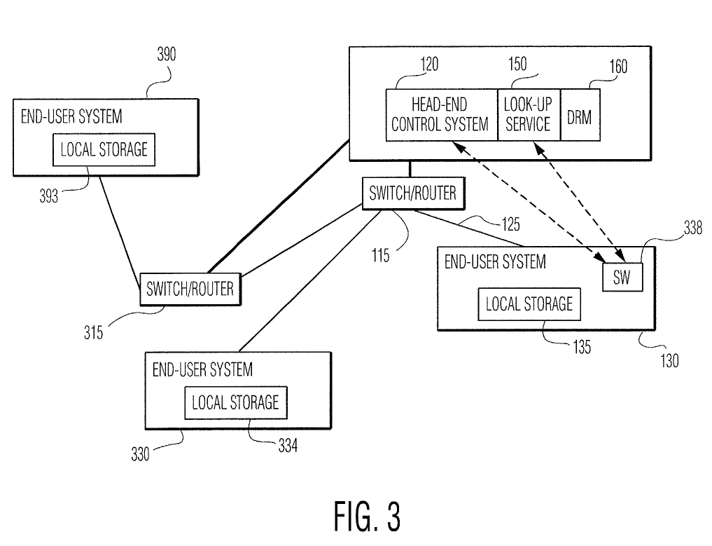

FIG. 3 is a diagram illustrating further functionalities of system 100 that get invoked when the end-user of system 130 selects a content item for direct or scheduled play-out. A software component 338 interacts with look-up service 150 to obtain information about the network location of the selected content item or its parts. Assume that a part of this content item resides at a local storage 334 of an end-user system 330 within SAN 110. Look-up service 150 provides this information to software component 338 that then initiates the downloading of this content part from end-user system 330 via switch/router 115. Preferably, Router-Intelligent dynamic routing algorithms are used in the process. If the content upload/download ratio is not sufficient for play-out, control system 120 is enabled to instruct software 338 to obtain part(s) of the requested content from at least one alternative source, here local storage 393 of an end-user system 390. Software 338 is preferably enabled to mask content download latency by content already available on the local storage 135. Within this context, see, e.g., U.S. Ser. No. 09/433,257 (attorney docket PHA 23,782) mentioned above. Control system 120 may also be enabled to modify the upload/download bandwidth ratio at a network location closest to system 330, e.g. router 315. The content downloaded to local storage may be registered with look-up service 150 for future distribution within to other end-users in SAN 110.

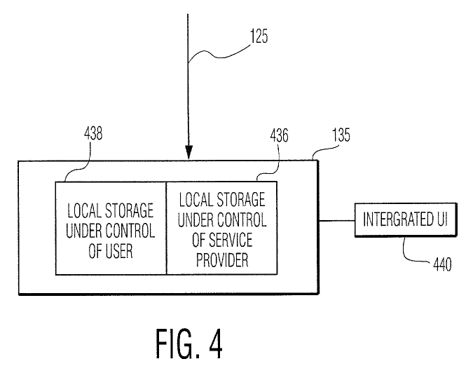

FIG.4 is a diagram illustrating a hybrid configuration of local storage 135. Local storage 135 comprises a portion 436 that is under control of the service provider or content provider, e.g., for the purpose of establishing a distributed content storage using the end-users' equipment as explained above. Preferably, the user of the equipment accommodating local storage 135 is not even aware of the content stored locally in portion 436. Local storage also comprises a portion 438 that is under control of the user and that is not necessarily exposed to the service. Preferably, both are represented in an integrated user interface 440 if the user has access to the content in both parts. Within this context, reference is made to U.S. Ser. No. 09/568,932(attorney docket US 000106) filed May 11 2000 for Eugene Shteyn and Rudy Roth for ELECTRONIC CONTENT GUIDE RENDERS CONTENT RESOURCES TRANSPARENT, herein incorporated by reference. This document relates to a data management system on a home network. The system collects data that is descriptive of content information available at various resources on the network, including an electronic program guide (EPG). The data is combined in a single menu to enable the user to select from the content, regardless of the resource.

The following documents are incorporated herein by reference as well:

U.S. Ser. No. 09/283,545 (attorney docket PHA 23,633) filed Apr. 1, 1999 for Eugene Shteyn for TIME- AND LOCATION-DRIVEN PERSONALIZED TV. This document relates to a method of enabling a user to access content information (e.g., video, audio). The method enables the user to select the content information, e.g., from an electronic program guide relating to a broadcast or multicast service. The selected content information gets recorded when it is broadcasted or multicasted. The method enables the user to select in advance at least a specific one from multiple geographically different locations at which the recorded, selected content information will be made available for play-out. Preferably, the user is also enabled to specify a time frame for making the recorded content information available for play-out at the specific location. The content information can be recorded at a first recording system, e.g., at a server, whereafter the recorded selected content information is streamed over a data network, e.g., over the Internet or a private network like AOL, from the first recording system to the location specified by the user. If the specific location has a second recording system, the streaming uses a low-bandwidth protocol so as to keep Internet bandwidth usage low while recording at the second recording system. The user specifies in advance a location for play-out of a specific broadcast or multicast program pre-recorded in response to the user's selection. The user has the content made available to him or her at that location. For example, the user can specify that he or she will be, e.g., at the house of a relative, at a specific hotel, on a particular flight of a specific airline, in a specific bar, a particular restaurant, etc., at a specific time period, and request that the content be recorded at this location. This requires that these other locations be integrated in the infrastructure of the service mentioned above.

U.S. Ser. No. 09/406,642 (attorney docket PHA 23,768) filed Sep. 27, 1999 for Raoul Mallart for SCALABLE SYSTEM FOR VIDEO-ON-DEMAND. This document relates to a VOD service that is emulated in an NVOD (near-video-on-demand) architecture. Content information is made available to an end-user in the NVOD architecture. An introductory portion of the content information is stored at the end-user's equipment, e.g., by downloading overnight. During playing out of the introductory portion at the end-user enabling the content information supplied in the NVOD architecture is buffered at the end-user's equipment. The equipment is controlled to switch from playing out the introductory portion stored to playing out the buffered content information.

U.S. Ser. No. 09/521,051 (attorney docket U.S. 000052) filed Mar. 8, 2000 for Geert Bruynsteen for BUSINESS MODEL FOR LEASING STORAGE SPACE ON A DIGITAL RECORDER. This document relates to adjusting the available amount of storage space of a fixed HDD on a CE device via a data network. The consumer can upgrade the device via a third party service that remotely control's the HDD's settings.

U.S. Ser. No. 09/374,694 (attorney docket PHA 23,737) filed Aug. 16, 1999 for Chanda Dharap for SEMANTIC CACHING, herein incorporated by reference. This document relates to the caching of electronic content information based on its semantic type. The cache management strategy is customized for each semantic type, using different caching policies for different semantic types. Semantic types that can be expected to contain dynamic information, such as news and weather, employ an active caching policy wherein the content information in the cache memory is chosen for replacement based on the duration of time that the information has been in cache memory. Conversely, semantic types that can be expected to contain static content information, such as encyclopedic information, employ a more conservative caching strategy, such as LRU (Last Recently Used) and LFU (Least Frequently Used) that is substantially independent of the time duration that the information remains in cache memory. Additionally, some semantic types, such as communicated e-mail messages, newsgroup messages, and so on, may employ a caching policy that is a combination of multiple strategies, wherein the content information progresses from an active cache with a dynamic caching policy to a more static caches with increasing less dynamic caching policies. The relationship between semantic content type and caching policy to be associated with the type can be determined in advance, or may be determined directly by the user, or could be based, at least partly, on user-history and profiling of user-interaction with the content information.

U.S. Ser. No. 09/802,618 (attorney docket U.S. 018028) filed Mar. 8, 2001 for Eugene Shteyn for ACTIVITY SCHEDULE CONTROLS PERSONALIZED ELECTRONIC CONTENT GUIDE. This document relates to determining electronic content information and the time slots for play-out based on the activities scheduled in the user's electronic calendar and the user's profile or declared interests. In this manner, the recording and downloading of content is automated based on the user's life style.

What is claimed is:

1. A method of enabling multiple end-users to receive content information, the method comprising:
supplying the content information to a hub; and
using a peer-to-peer network of respective devices residing at respective ones of the end-users and connected to the hub for distributed storage of the content information on the network under control of the hub.

2. The method of claim 1, comprising remotely controlling a specific one of the devices for supplying the stored content information to at least another one of the devices.

3. The method of claim 1, comprising a service for supplying an electronic content guide representing the content information available on the network.

4. The method of claim 1, using a plurality of hubs, each respective one thereof connected to a respective one of a number of peer-to-peer networks.

5. The method of claim 1, comprising controlling the devices.

6. The method of claim 1, comprising providing a UI to the end-users for selecting from the content information.

7. A device for use in a method of enabling multiple end-users to receive content information, wherein:
the method comprises:
supplying of the content information to a hub; and
using a peer-to-peer network of devices residing at the end-users connected to the hub for distributed storage of the content information on the network under control of the hub; and
the device comprises:
a storage for storing at least part of the content information; and
a controller for providing, to a party different from any from the end-users, remote control of the device for supplying the stored content information to the network.

8. A consumer electronics device comprising a storage for storing content information from a network and for supplying the content information to the network, and comprising a control module for remote control of the storing and supplying.
